(19) United States
(12) Patent Application Publication
(10) Pub. No.: US 2005/0043916 A1
(43) Pub. Date: Feb. 24, 2005

(54) Point cloud data importing system and method

(75) Inventors: Xin-Yuan Wu, Shenzhen (CN); Chih-Kuang Chang, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-cheng City (TW)

(21) Appl. No.: 10/892,675

(22) Filed: Jul. 16, 2004

(30) Foreign Application Priority Data
Aug. 20, 2003 (TW) 921222810

(51) Int. Cl. G06F 15/00

(52) U.S. Cl. 702/167

(57) ABSTRACT

A point cloud data importing system includes at least one scanning apparatus (2), and an application server (1). The scanning apparatus is for generating point cloud data by scanning objects. The application server includes: a point cloud data receiving module (11) for receiving point cloud data from the scanning apparatus, converting the point cloud data into a computer-recognizable format, and integrating the point cloud data into a point cloud file; a point cloud data retrieving module (12) for retrieving point cloud data from the point cloud file; and a point cloud data processing module (13) for converting the point cloud data into decimal numbers, generating 3-dimensional coordinate values of points, and importing the 3-dimensional coordinate values of the points into a CAD system in order to construct a block which precisely replicates the shape of the scanned object. A related point cloud data importing method is also provided.

### BACKGROUND OF THE INVENTION

1. Field of the Invention

The present invention relates to computer-enabled data importing and processing systems and methods, and particularly to a system and method for importing point cloud data.

2. Related Art of the Invention

Product quality has long been one of the most important factors in maintaining a typical manufacturing enterprise's competitiveness. How to improve the quality of products is an important ongoing pursuit of such enterprise. It is essential to verify the correctness and accuracy of components of various assembled products. With many manufactured products becoming increasingly complex, the burden of verification is growing correspondingly. There is now a burgeoning need to verify components of products rapidly and precisely. Nevertheless, many enterprises still perform verification by employing numerous manual tasks and test programs that are non-standard. This can slow down output, and can seriously affect the accuracy and consistency of the verification performed.

With the performance of computer hardware and software continually improving and with the prices of such equipment becoming more competitive, computers nowadays play a major role in the process of verification. Computer equipment can greatly improve the efficiency and accuracy of verification. The art of verifying three-dimensional digital models of objects is disclosed in patents such as U.S. Pat. No. 6,377,865, entitled Methods of Generating Three-dimensional Digital Models of Objects by Wrapping Point Cloud Data Points. This invention can automatically represent a physical object in the form of point cloud data, and can verify the object by comparing a three-dimensional digital model of the object with the point cloud data. The point cloud data are images obtained by measuring the object using a measurement apparatus. However the invention does not disclose how to rapidly construct a block which precisely replicates the shape of an object (i.e., a three dimensional digital model of the object) after scanning of the object.

There is a need for a system and method which can rapidly construct a block that precisely replicates the shape of a scanned object.

### SUMMARY OF THE INVENTION

Accordingly, a main objective of the present invention is to provide a point cloud data importing system and method, which can import point cloud data and construct a block automatically and rapidly.

To accomplish the above objective, a point cloud data importing system in accordance with a preferred embodiment of the present invention is provided herein. The point cloud data importing system comprises at least one scanning apparatus and an application server. The scanning apparatus is for generating point cloud data by scanning objects. The application server comprises: a point cloud data receiving module for receiving the point cloud data from the scanning apparatus, converting the point cloud data into a computer-recognizable format in which the point cloud data are expressed in the form of character strings, and integrating the point cloud data into a point cloud file; a point cloud data retrieving module for retrieving the point cloud data from the point cloud file; a point coordinate value generating module for converting the character strings into decimal numbers, and generating 3-dimensional coordinate values of points according to the decimal numbers; a point cloud coordinate value importing module for importing the 3-dimensional coordinate values into a CAD (Computer Aided Design) system, and constructing a block according to the 3-dimensional coordinate values; and a block displaying module for displaying the block in the CAD system.

Further, the present invention provides a point cloud data importing method, the method comprising the steps of: (a) providing a scanning apparatus for scanning an object and generating point cloud data on the object; (b) receiving the point cloud data from the scanning apparatus and converting the point cloud data into a computer-recognizable format, the point cloud data in the computer-recognizable format being expressed in the form of character strings; (c) converting the character strings into decimal numbers and generating 3-dimensional coordinate values of points according to the decimal numbers; (d) importing the 3-dimensional coordinate values into a CAD system and constructing a block; and (f) displaying the block in the CAD system.

Other objects, advantages and novel features of the present invention will be drawn from the following detailed description of the preferred embodiment and preferred method of the present invention with the attached drawings, in which:

### BRIEF DESCRIPTION OF THE DRAWINGS

FIG. 1 is a schematic diagram of hardware and software infrastructure of a point cloud data importing system in accordance with the preferred embodiment of the present invention;

FIG. 2 is a flowchart of a preferred method for implementing the point cloud data importing system of FIG. 1;

FIG. 3 is a flowchart of a preferred method for implementing one of the steps of FIG. 2, namely processing point cloud data and constructing a block;

FIG. 4 is a flowchart of a preferred method for implementing one of the steps of FIG. 3, namely converting a character string into decimal numbers, and generating coordinate values of a point; and

FIG. 5 is a flowchart of a preferred method for implementing another of the steps of FIG. 3, namely displaying the block in one of CAD 3-dimensional coordinate systems of a CAD system.

### DETAILED DESCRIPTION OF THE PREFERRED EMBODIMENT

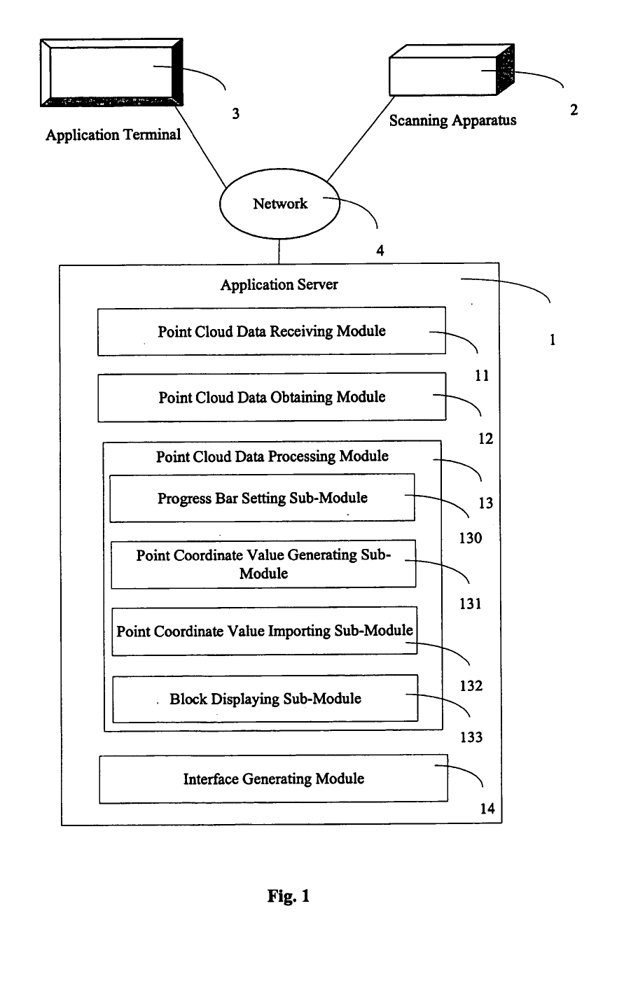

FIG. 1 is a schematic diagram of hardware and software infrastructure of a point cloud data importing system in accordance with the preferred embodiment of the present invention. The point cloud data importing system comprises an application server 1, at least one scanning apparatus 2, and a plurality of application terminals 3 (only one shown), each being in communication with all of the others via a network 4. The network 4 may be any suitable communication architecture required by the point cloud data importing system, such as the Internet or an intranet.

The scanning apparatus 2 is used for scanning an object and generating point cloud data on the object. The point cloud data can be generated by scanning the surface of the object (surface scan) or by scanning the entire region of the object (solid scan), and comprise a plurality of discrete points. The application server 1 is used for receiving the point cloud data from the scanning apparatus 2, processing the point cloud data, and constructing an electronic image of a block which precisely replicates the shape of the scanned object.

The application server 1 comprises: a point cloud data receiving module 11, a point cloud data retrieving module 12, a point cloud data processing module 13, and an interface generating module 14. The point cloud data receiving module 11 is used for receiving the point cloud data from the scanning apparatus 2, and converting the point cloud data into a computer-recognizable format such as a text format, in which the point cloud data are expressed in the form of character strings. The point cloud data receiving module 11 is also used for integrating the point cloud data in the computer-recognizable format into a particular electronic file, which hereinafter is referred to as a point cloud file. The point cloud data retrieving module 12 is used for retrieving the point cloud data from the point cloud file. The point cloud data processing module 13 is used for automatically processing the point cloud data, and constructing an electronic image of a block in a CAD (Computer Aided Design) system. The CAD system resides in the application server 1, and may be an AutoCAD system, a pro/E system or a 3D Max system. According to the preferred embodiment, the CAD system includes a CAD database and a plurality of 3-dimensional coordinate systems, which hereinafter are referred to as CAD 3-dimensional coordinate systems. The block is constructed in the CAD database and displayed in one of the CAD 3-dimensional coordinate systems.

The point data processing module 13 comprises a plurality of sub-modules: a progress bar setting sub-module 130, a point coordinate value generating sub-module 131, a point coordinate value importing sub-module 132, and a block displaying sub-module 133.

The progress bar setting sub-module 130 is used for setting a progress bar to monitor the progress of importing the point cloud data into the CAD database. The point coordinate value generating sub-module 131 is used for converting character strings in the point cloud file into decimal numbers; for example, converting the character strings into double-precision numbers (i.e., numbers expressed to an accuracy of 8 decimal places). The point coordinate value generating sub-module 131 is also used for generating 3-dimensional coordinate (XYZ) values of the points according to the decimal numbers. The coordinate values of each point comprise an X-coordinate value, a Y-coordinate value and a Z-coordinate value. The point coordinate value importing sub-module 132 is used for importing the coordinate values of the points into the CAD database, and constructing a block which precisely replicates the shape of the scanned object in the CAD database. The block displaying sub-module 133 is used for displaying the block in one of the CAD 3-dimensional coordinate systems. The interface generating module 14 is used for generating an interface, which connects the point cloud data importing system with other systems. This enables users of the other systems to make use of the point cloud data importing system when required.

The application terminals 3 are for utilizing the block to measure and analyze the scanned object; for example, to measure the points and to mark with colors differences between the block and a reference ideal model of the object.

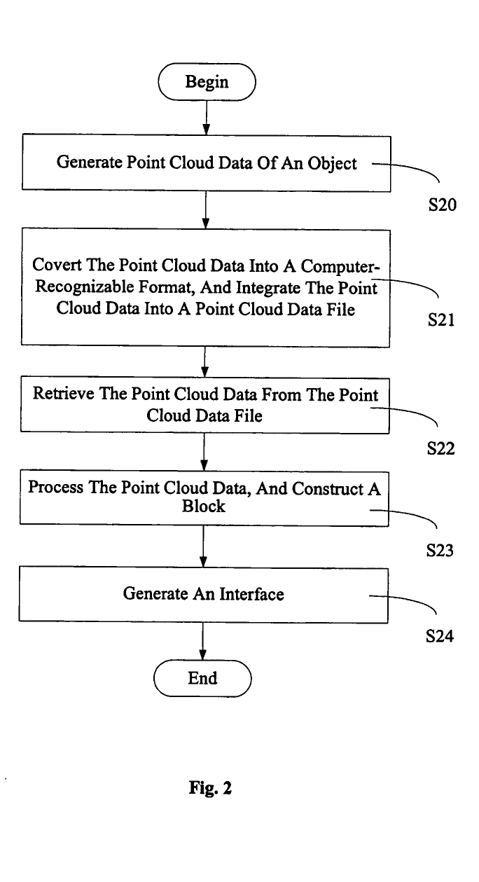

FIG. 2 is a flowchart of a preferred method for implementing the point cloud data importing system. In step S20, the scanning apparatus 2 generates point cloud data on an object by scanning the object. In step S21, the point cloud data receiving module 11 receives the point cloud data from the scanning apparatus 2, converts the point cloud data into a computer-recognizable format in which the point cloud data are expressed in the form of character strings, and integrates the point cloud data into a point cloud file. In step S22, the point cloud data retrieving module 12 retrieves the point cloud data from the point cloud file. In step S23, the point cloud data processing module 13 processes the point cloud data, constructs a block which precisely replicates the shape of the scanned object in a CAD system, and displays the block. In step S24, the interface generating module 14 generates an interface to connect the point cloud data importing system with other systems. This enables users of the other systems to make use of the point cloud data importing system when required.

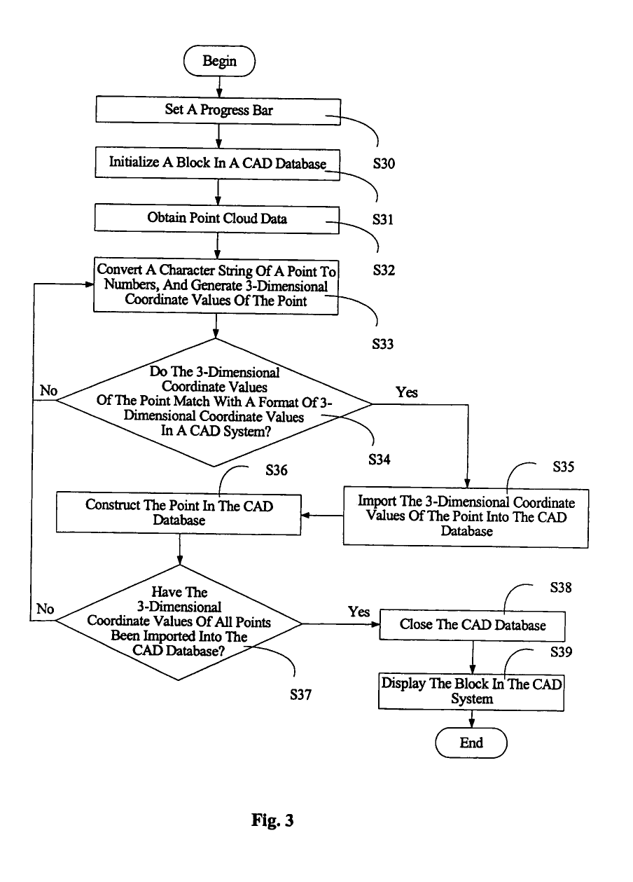

FIG. 3 is a flowchart of a preferred method for implementing step S23 of FIG. 2, namely processing the point cloud data and constructing a block. In step S30, the progress bar setting sub-module 130 sets a progress bar, specifies a maximum value for the progress bar which is equal to the number of points in the point cloud data, and sets the initial value of the progress bar as “0.” According to the preferred embodiment, when 3-dimensional coordinate values of any point are imported into the CAD database, the value of the progress bar is increased by “1.” When all the coordinate values of the points have been imported into the CAD database, the value of the progress bar has reached the maximum value.

In step S31, the point cloud data retrieving module 12 initializes the block in the CAD database. Such initialization includes: naming the block, defining properties and colors of the block, selecting a scale for constructing the block, and selecting a reference point as an origin of coordinates (XYZ) for importing the coordinate values of the points into the CAD database. In step S32, the point cloud data retrieving module 12 retrieves the point cloud data which are expressed in the form of character strings from the point cloud file. In step S33, the point coordinate value generating sub-module 131 converts a character string of a point into decimal numbers, and generates 3-dimensional coordinate values of the point according to the decimal numbers. The 3-dimensional coordinate values of the point include an X-coordinate value, a Y-coordinate value and a Z-coordinate value. According to the preferred embodiment of the present invention, “enters” and “line-breaks” are used to differentiate a character string of a point, typically a combination of binary digits, from other character strings of other points. Two “spaces” are used to divide a character string into three parts. Each part of the character string is converted into a decimal number which corresponds to a 3-dimensional coordinate value of the point. The three decimal numbers respectively represent an X-coordinate value, a Y-coordinate value, and a Z-coordinate value of the point.

In step S34, the point cloud data processing module 13 determines whether the 3-dimensional coordinate values of the point match with a format of 3-dimensional coordinate values in the CAD system. That is, the point cloud data processing module 13 determines whether the 3-dimensional coordinate values of the point are decimal numbers that meet with a preset precision. In the preferred embodiment, the preset precision is double-precision, and is determined by users of the point cloud data importing system. If any 3-dimensional coordinate values of the point do not match with the format of 3-dimensional coordinate values in the CAD system, the procedure returns to step S33 described above. If the 3-dimensional coordinate values of the point match with the format of the 3-dimensional coordinate values in the CAD system, in step S35, the point coordinate value importing sub-module 132 imports the 3-dimensional coordinate values of the point to the CAD database. In step S36, the point cloud data processing module 13 constructs the point in the CAD database according to the 3-dimensional coordinate values of the point and according to the selected reference point. In step S37, the point cloud data processing module 13 determines whether the 3-dimensional coordinate values of all points have been imported into the CAD database according to a current value of the progress bar. If the current value of the progress bar has not reached the maximum value, this means that there are one or more 3-dimensional coordinate values of one or more points that have not been imported into the CAD database, and accordingly the procedure returns to step S33 described above. If the current value of the progress bar has reached the maximum value, this means that the coordinate values of all the points have been imported into the CAD database and the block has been fully constructed. Accordingly, in step S38, the point cloud data retrieving module 12 closes the CAD database. Then in step S39, the block displaying sub-module 133 displays the block in one of the CAD 3-dimensional coordinate systems of the CAD system.

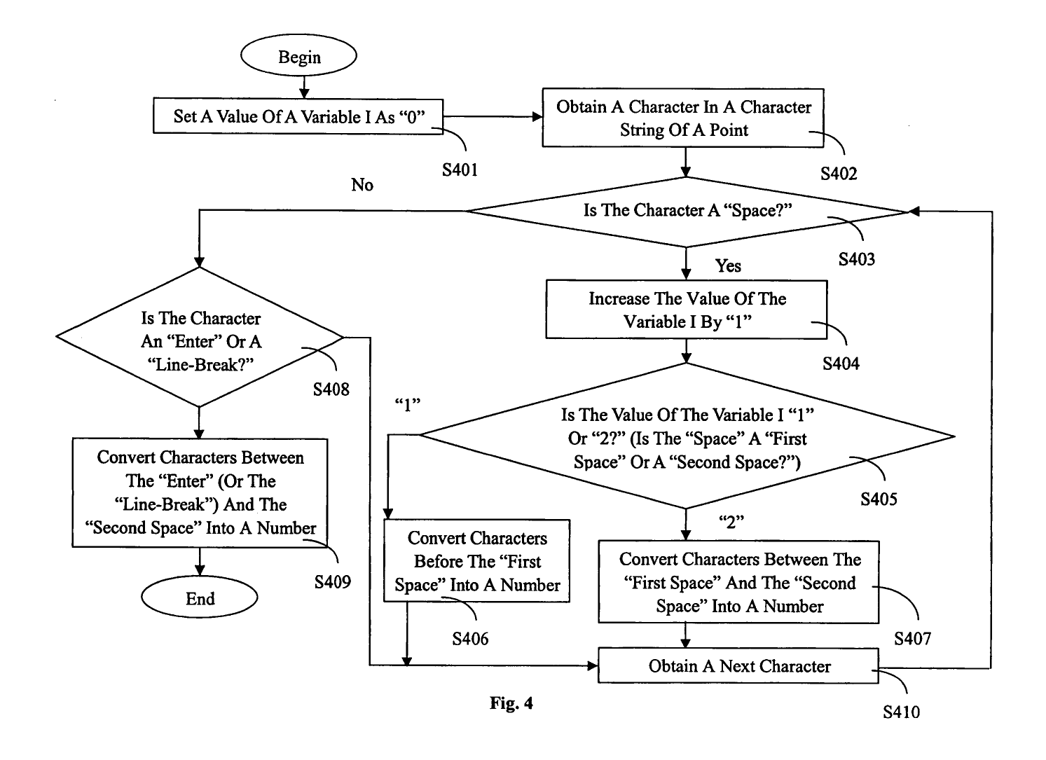

FIG. 4 is a flowchart of a preferred method for implementing step S33 of FIG. 3, namely converting a character string of a point into decimal numbers, and generating 3-dimensional coordinate values of the point. In step S401, the point coordinate value generating sub-module 131 (“the sub-module 131”) sets a value of a variable I as “0.” In step S402, the sub-module 131 obtains a character from the character string of the point. In step S403, the sub-module 131 determines whether the character is a “space.” If the character is a “space,” in step S404, the sub-module 131 increases the value of the variable I by “1.” Then in step S405, the sub-module 131 determines whether the value of the variable I is “1” or “2.” That is, the sub-module 131 determines whether the “space” is a first-appearing “space” (hereinafter referred to as a “first space”) or a second-appearing “space” (hereinafter referred to as a “second space”) before the appearance of an “enter” (or a “line-break”). If the value of the variable I is “1” (i.e., the “space” is a “first space”), in step S406, the sub-module 131 converts characters before the “first space” into a decimal number. The decimal number is treated as the X-coordinate value of the point in the CAD system. Then the procedure goes directly to step S410 described below. If the value of the variable I is “2” (i.e., the “space” is a “second space”), in step S407, the sub-module 131 converts characters between the “first space” and the “second space” into a decimal number. The decimal number is treated as the Y-coordinate value of the point in the CAD system. Then the procedure goes directly to step S410 described below.

If the character is not a “space,” in step S408, the sub-module 131 determines whether the character is an “enter” or a “line-break.” If the character is an “enter” or a “line-break,” in step S409, the sub-module 131 converts the characters between the “enter” (or the “line-break”) and the “second space” into a decimal number. The decimal number is treated as the Z-coordinate value of the point in the CAD system, and the procedure is thus ended. If the character is not an “enter” or a “line-break,” the procedure goes directly to step S410 described below.

In step S410, the sub-module 131 obtains a next character in the character string, whereupon the procedure returns to step S403 described above.

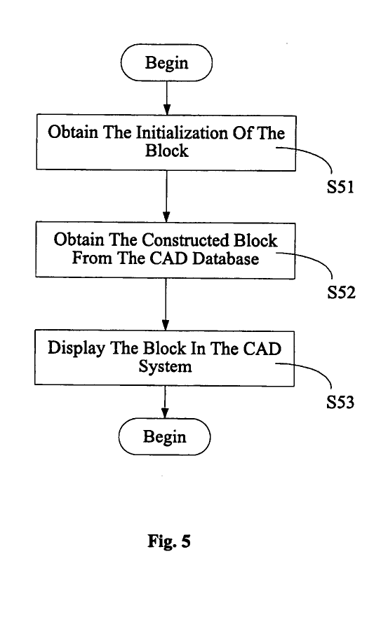

FIG. 5 is a flowchart of a preferred method for implementing step S39 of FIG. 3, namely displaying a block in one of the CAD 3-dimensional coordinate systems of the CAD system. In step S51, the block displaying sub-module 133 obtains the initialization of the block from the CAD database, including a name, properties, colors, a scale for constructing the block, and a reference point. In step S52, the block displaying sub-module 133 obtains the constructed block from the CAD database. In step S53, the block displaying sub-module 133 displays the block in one of the CAD 3-dimensional coordinate systems of the CAD system.

Although the present invention has been specifically described on the basis of a preferred embodiment and a preferred method, the invention is not to be construed as being limited thereto. Various changes and modifications may be made to the embodiment and method without departing from the scope and spirit of the invention.

1. A point cloud data importing system for importing point cloud data into a Computer Aided Design (CAD) system in order to construct blocks which replicate the shapes of scanned objects, the point cloud data importing system comprising:
at least one scanning apparatus for scanning the objects and generating point cloud data on the scanned objects; and
an application server for receiving the point cloud data from the scanning apparatus, processing the point cloud data and constructing the blocks according the processed point cloud data, the application server comprising:
a point cloud data receiving module for receiving point cloud data from the scanning apparatus, converting the point cloud data into a computer-recognizable format, and integrating the point cloud data into a point cloud file, wherein the point cloud data in the computer-recognizable format are expressed in the form of character strings;
a point cloud data retrieving module for retrieving the point cloud data from the point cloud file;
a point coordinate value generating module for converting the character strings into numbers, and generating 3-dimensional coordinate values of points according to the numbers;
a point coordinate value importing module for importing the 3-dimensional coordinate values into the CAD system, and constructing a block according to the 3-dimensional coordinate values; and
a block displaying module for displaying the constructed block in the CAD system.

2. The point cloud data importing system according to claim 1, further comprising at least one application terminal for utilizing the constructed block to measure and analyze the scanned object.

3. The point cloud data importing system according to claim 1, wherein the application server further comprises an interface generating module for generating an interface to enable users of other systems to make use of the point cloud data importing system.

4. The point cloud data importing system according to claim 1, wherein the application server further comprises a progress bar setting module for setting a progress bar to monitor the progress of importing the 3-dimensional coordinate values into the CAD system.

5. A computer-enabled point cloud data importing method, comprising:
providing a scanning apparatus for scanning an object and generating point cloud data on the object;
receiving the point cloud data from the scanning apparatus, and converting the point cloud data into a computer-recognizable format, wherein the point cloud data in the computer-recognizable format are expressed in the form of character strings;
converting the character strings of the point cloud data into numbers, and generating 3-dimensional coordinate values for points of the point cloud data according to the numbers;
importing the 3-dimensional coordinate values into a CAD system, and constructing a block which replicates the shape of the scanned object; and
displaying the block in the CAD system.

6. The method according to claim 5, further comprising the step of setting a progress bar to monitor the progress of importing the 3-dimensional coordinate values into the CAD system.
